(19) United States
(12) Patent Application Publication
(10) Pub. No.: US 2013/0110826 A1
(43) Pub. Date: May 2, 2013

(54) METHOD FOR SEARCHING CONTACTS, ELECTRONIC APPARATUS, AND STORAGE MEDIUM USING THE METHOD THEREOF

(71) Applicant: Yuan-Mao Tsui, Taoyuan County (TW)

(72) Inventor: Yuan-Mao Tsui, Taoyuan County (TW)

(73) Assignee: HTC CORPORATION, Taoyuan County (TW)

(21) Appl. No.: 13/282,473

(22) Filed: Oct. 27, 2011

(51) Int. Cl. G06F 17/30

(52) U.S. Cl. 707/724; 707/E17.014

(57) ABSTRACT

A method for searching contacts, an electronic apparatus, and a storage medium using the method thereof are provided. A geographic location is received for determining a positioning coordinate corresponding to the geographic location. A number of times of a landmark positioning performed by each of the contacts at the positioning coordinate is calculated. At least one contact is output according to the number of times of landmark positioning of each of the contacts.

### BACKGROUND

1. Field of the Invention

The present invention generally relates to a data search method, in particular, to a method and an electronic apparatus for searching contacts through a positioning coordinate.

2. Description of Related Art

With the rise of the Internet, modern people regard web browsing as a daily leisure activity due to the convenience brought by the Internet. With the development of social network web sites, the network no longer only has the usage of querying data, and numerous users can carry out discussion and interaction and share moods and information with each other through the social network web site. The user not only can share his/her state, recent situation and location with friends through the social network web site, but also can get news about friends and ask questions to seek answers from friends through the social network web site.

In the past, when the user intends to go to an unfamiliar place, the users generally tries to contact a local friend or searches for data related to the place through the network. However, the user may not know which friend is the person most familiar with the place, and the information found through the network may not be complete. Moreover, with the rise of the social network web site, the user may also send a message through the social network web site to query whether a friend in a friend group has been to the place and query opinions of the friend having been to the place. However, this method is rather passive, and when excessive messages exist in a page of the social network web site, the message is easily ignored.

### SUMMARY

Accordingly, the present invention is directed to a method and an electronic apparatus for searching contacts, which are capable of searching contacts through a point of interest.

The present invention provides a method for searching contacts, applicable to an electronic apparatus. In the method, a geographic location is received, and a positioning coordinate corresponding to the geographic location is determined. A number of times of landmark positioning performed by each of contacts at the positioning coordinate is calculated. At least one contact is output according to the numbers of times of landmark positioning of the contacts.

In an embodiment of the present invention, after the step of determining the positioning coordinate corresponding to the geographic location, a contact performing landmark positioning at the positioning coordinate may be searched for according to the positioning coordinate.

In an embodiment of the present invention, after the step of receiving the geographic location, a region range may be determined according to the geographic location, so as to search for a contact performing landmark positioning in the region range.

In an embodiment of the present invention, after the step of receiving the geographic location, a region range may be determined according to the geographic location, so as to search for the positioning coordinate in the region range.

In an embodiment of the present invention, after the step of searching for the positioning coordinate in the region range, a contact performing landmark positioning at the positioning coordinate may be searched for according to the positioning coordinate.

In an embodiment of the present invention, a connection to a server may be established, so as to log in to the server through an account. Further, contacts corresponding to the account and a positioning coordinate where each of the contacts performs landmark positioning are read in the server, so as to search for a positioning coordinate corresponding to the geographic location in the positioning coordinates.

In an embodiment of the present invention, in the step of determining the positioning coordinate corresponding to the geographic location, all positioning coordinates corresponding to the geographic location may be listed first, and then a positioning coordinate where the contacts perform landmark positioning may be selected from the positioning coordinates.

In an embodiment of the present invention, in the step of determining the positioning coordinate corresponding to the geographic location, all positioning coordinates corresponding to the geographic location may be listed first, and then a selection instruction may be received to select one or more positioning coordinates from all the positioning coordinates.

In an embodiment of the present invention, after the step of calculating the number of times of landmark positioning performed by each of the contacts at the positioning coordinate, the number of times of landmark positioning of each of the contacts may be compared with a threshold value, so as to list the contacts having a number of times of landmark positioning greater than the threshold value. Furthermore, the contacts may be sorted according to the numbers of times of landmark positioning of the contacts. Furthermore, a location of each of the contacts may further be obtained, and a weight value of each of the contacts corresponding to the geographic location may be calculated according to the location and the number of times of landmark positioning of each of the contacts to sort the contacts.

From another point of view, the present invention provides an electronic apparatus, comprising a connection unit, an output unit, and a processing unit. The processing unit is coupled to the connection unit and the output unit respectively, and is connected to a server through the connection unit. Here, the server includes a plurality of positioning coordinates. The processing unit receives a geographic location, determines a positioning coordinate corresponding to the geographic location, calculates a number of times of landmark positioning performed by each of contacts at the positioning coordinate, and outputs at least one of the contacts to the output unit according to the numbers of times of landmark positioning of the contacts.

In an embodiment of the present invention, the electronic apparatus further comprises a storage unit. The storage unit is coupled to the processing unit and used for storing all positioning coordinates downloaded from the server and where the contacts perform landmark positioning, so that the processing unit searches the storage unit for the positioning coordinate corresponding to the geographic location.

In an embodiment of the present invention, the processing unit further lists all positioning coordinates corresponding to the geographic location and selects a positioning coordinate where the contacts perform landmark positioning from the positioning coordinates. Furthermore, the processing unit may compare the number of times of landmark positioning of each of the contacts at the geographic location with a threshold value, so as to list the contacts having a number of times of landmark positioning greater than the threshold value, and sort the contacts according to the numbers of times of landmark positioning. Furthermore, the processing unit may further obtain a location of each of the contacts, and calculate a weight value of each of the contacts corresponding to the geographic location according to the location and the number of times of landmark positioning to sort the contacts.

The present invention provides a storage medium, including a computer program product for executing the method for searching contacts. The computer program product basically consists of a plurality of program code segments (for example, program code segments for creating an organization chart, sign-off form program code segments, setting program code segments, and deployment program code segments). After the program code segments are loaded into the electronic apparatus and are executed, the steps of the method for searching contacts and the functions of the electronic apparatus can be implemented.

Based on above, in the present invention, contacts having been to a specified geographic location are searched for by using a positioning coordinate, so as to provide contacts worth being queried for reference by the user.

In order to make the aforementioned and other objectives and advantages of the present invention comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a method for searching contacts according to an embodiment of the present invention.

FIG. 2 is a schematic diagram of a network system according to an embodiment of the present invention.

### DESCRIPTION OF THE EMBODIMENTS

In the past, when a user intends to query a contact group about information related to a specified place, no simple method is available for learning whether the contacts have been to the specified place, and even if the user knows that a contact has been to the specified place, the user cannot know whether the contact is familiar with the specified place. Therefore, the present invention provides a method and an electronic apparatus for searching contacts, which may be combined with a landmark positioning function to search for contacts having been to a specified place. In order to make the content of the present invention clearer, embodiments listed below are described as examples according to which the present invention can surely be implemented.

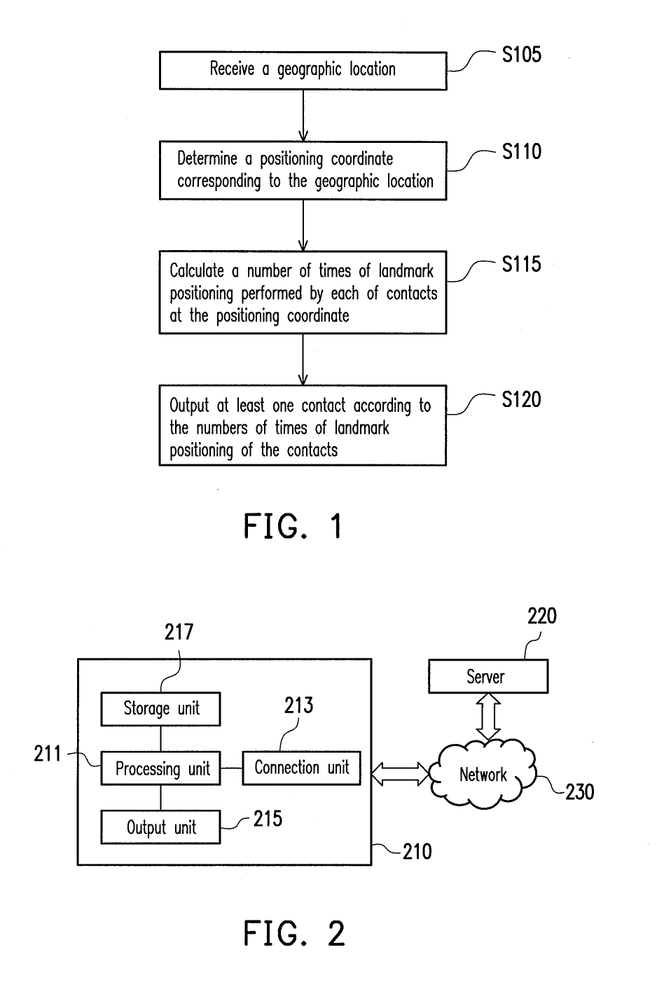

FIG. 1 is a flow chart of a method for searching contacts according to an embodiment of the present invention. In this embodiment, steps of the method for searching contacts below are executed by an electronic apparatus. The electronic apparatus may be an electronic apparatus having a communication and/or network transmission function or a mobile communication apparatus, such as a mobile phone, a smart phone, a personal computer, a notebook computer, a tablet computer, a navigation apparatus, or an electronic gaming machine. Here, the scope of the electronic apparatus is not limited.

Referring to FIG. 1, in Step S105, a geographic location is received. For example, a user may input a geographic location where the user intends to go or is currently located to the electronic apparatus. For example, the geographic location may be input by the user or selected from a location list, where the location list may be, for example, an administrative region list, a list of points of interest, or the like. Furthermore, the geographic location, for example, a midway point or an end point of a travel route, may also be captured from a specific application (for example, an application capable of setting a travel route). Alternatively, the geographic location where the user is currently located may be directly captured through a positioning system. Here, the scope of capturing the geographic location is not limited.

Then, in Step S110, a positioning coordinate corresponding to the geographic location is determined. For example, the positioning coordinates corresponding to the geographic location are listed, and a selection instruction for selecting the positioning coordinates is received, that is, to select one or more positioning coordinates from all the positioning coordinates.

For example, the user is connected to one or more servers through the electronic apparatus, logs in to the server through an account, and determines the positioning coordinate corresponding to the geographic location in the server. The positioning coordinate may be, for example, a point of interest. The point of interest may be created by the server or the user. The positioning coordinate may also be a location having latitude and longitude coordinates. For example, when the user selects a geographic location from an administrative region list, the geographic location may include a plurality of positioning coordinates, that is, a plurality of points of interest; while when the user selects a geographic location from a list of points of interest (or a positioning coordinate list), the geographic location may correspond to only one positioning coordinate, that is, correspond to a positioning coordinate of the point of interest.

Alternatively, contacts corresponding to the account and a positioning coordinate where each of the contacts performs landmark positioning through the server are read in the server, so as to search for the positioning coordinate corresponding to the geographic location in the positioning coordinates.

In an embodiment, all positioning coordinates corresponding to the geographic location may also be listed, and positioning coordinates where the contacts perform landmark positioning are selected from the positioning coordinates. Alternatively, in another embodiment, all positioning coordinates corresponding to the geographic location where server users perform landmark positioning may be first listed, and positioning coordinates where the contacts perform landmark positioning are selected from the positioning coordinates. Alternatively, in another embodiment, a selection instruction selected by a user may be further received to further select a positioning coordinate from the positioning coordinates.

For example, with the popularization of smart phones, when arriving at a place, many people may input an account into a smart phone to log in to a server to perform a check-in action (landmark positioning). The server may be, for example, a social network web site, software, an application, or a web page service having a check-in function. For example, a positioning system of the smart phone is used to position a current location, and is connected to a server to search a database of the server for the current location and created points of interest nearby, so as to list a plurality of points of interest for the user to select a place for check-in. Alternatively, after obtaining the current location by using the positioning system, the user may also create a point of interest through the smart phone as a place for check-in and meanwhile store the new point of interest into the database of the server. In this way, the database of the server records a plurality of points of interest and an account for check-in at each point of interest. When the user logs in to the server by using an account, by querying the database, the user can know at which points of interest the contact performs check-in actions, and time and a number of times of check-in; the user can also know at which points of interest the contact is tagged by other users or contacts, and time and a number of times of tagging; and the user can also know which users or contacts perform check-in actions at the points of interest, and time and a number of times of check-in.

Furthermore, after capturing the geographic location input by the user, the electronic apparatus may also determine a region range according to the geographic location, for example, a latitude and longitude range geographically covered by the geographic location, a specific range geographically covered by the geographic location, or an administrative region that the geographic location belongs to. In the case that the geographic location is “Taipei City”, the electronic apparatus may perform querying in a map database of the server or in combination with map databases of other network services or applications, so as to determine a region range of “Taipei City”, where the map database may be built in or previously downloaded in the electronic apparatus or may be a map database connected to a cloud end through a network. Alternatively, in the case that the positioning coordinate is the “Taipei Main Station”, the electronic apparatus may regard a region surrounding the “Taipei Main Station” as a region range. For example, the region range may be defined by a latitude and longitude coordinate range, or may be defined by a specific distance, or may be an administrative region “Taipei City” that the “Taipei Main Station” belongs to. Accordingly, after determining the region range according to the geographic location, the electronic apparatus searches for positioning coordinates where the contacts perform landmark positioning in the region range.

Afterward, in Step S115, a number of times of landmark positioning performed by each of the contacts at the geographic location is calculated according to the found positioning coordinate, so as to learn how familiar the contacts are with the geographic location according to the numbers of times of landmark positioning. The number of times of landmark positioning may be a number of times of check-in performed by the contact, optionally plus a number of times of tagging by other users or contacts.

Finally, in Step S120, a contact is output according to the numbers of times of landmark positioning of the contacts. For example, a contact performing a maximum number of times of landmark positioning is output, contacts performing first three maximum numbers of times of landmark positioning are output, or the contacts are output according to a descending order of the numbers of times of landmark positioning.

Furthermore, a threshold value may be set to be compared with the number of times of landmark positioning, so as to determine how familiar the contact is with the geographic location according to the threshold value. For example, after the number of times of landmark positioning performed by each contact at the geographic location is obtained, the number of times of landmark positioning performed by each contact may be compared with the threshold value, so as to determine whether the number of times of landmark positioning is greater than the threshold value. Here, if a number of times of landmark positioning performed by a contact is greater than the threshold value, the contact is active at the geographic location, indicating that the contact is more familiar with the geographic location than other contacts. Therefore, it may further be set to output only contacts having a number of times of landmark positioning greater than the threshold value.

Moreover, in addition to the number of times of landmark positioning, a location (work address, communication address, or residence address) of the contact may also be considered. For example, after the number of times of landmark positioning performed by each contact at the geographic location is obtained, the location of each contact is obtained, and then the contacts are sorted according to the location and the number of times of landmark positioning of each contact. For example, a weight value of each contact corresponding to the geographic location is calculated according to the location and the number of times of landmark positioning of each contact to sort the contacts. The location of the contact may be a current location of the contact, or may be a contact address, a residence address, a work address, or a school address of the contact, or may be an address of a company or school where the contact stayed before. For example, a higher reference value is given to a location closer to the geographic location, and then a weight value is obtained by performing an operation on the number of times of landmark positioning performed by each contact at the geographic location and the reference value of the location of the contact, and the contacts are sorted according to the weight values. Alternatively, a contact having a location being the same as the geographic location may be sorted ahead of others. Alternatively, a contact having a location being the same as the geographic location and performing landmark positioning at the positioning coordinate corresponding to the geographic location may be sorted ahead of others.

Form another point of view, the method for searching contacts may be executed by an electronic apparatus. FIG. 2 is a schematic diagram of a network system according to an embodiment of the present invention. Referring to FIG. 2, the network system comprises an electronic apparatus 210 and a server 220, where the electronic apparatus 210 is connected to the server 220 through a network 230. The server includes a plurality of points of interest. Here, the electronic apparatus 210 may be, for example, a mobile phone, a smart phone, a personal computer, a notebook computer, a tablet computer, a navigation apparatus, or an electronic gaming machine. The electronic apparatus 210 comprises a processing unit 211, a connection unit 213, an output unit 215, and a storage unit 217. The processing unit 211 is respectively coupled to the connection unit 213, the output unit 215, and the storage unit 217.

In this embodiment, the processing unit 211 receives a geographic location, is connected to the server 220 through the connection unit 213, and determines a positioning coordinate corresponding to the geographic location. The processing unit 211 may search for all positioning coordinates corresponding to the geographic location, and then select a positioning coordinate where contacts corresponding to a login account perform landmark positioning from the positioning coordinates; or first list all positioning coordinates where the contacts corresponding to the account perform landmark positioning, and then select a positioning coordinate corresponding to the geographic location from the positioning coordinates. Moreover, according to the obtained positioning coordinate, a number of times of landmark positioning performed by each contact at the positioning coordinate corresponding to the geographic location is calculated, and at least one contact is output to the output unit 215 according to the numbers of times of landmark positioning of the contacts.

The connection unit 213 is connected to the server 220 through the network 230. The output unit 215 is, for example, an apparatus such as a screen or a loudspeaker. That is to say, the electronic apparatus 210 may present the found contact in a visual manner or a speech manner. The storage unit 217 is used to store a positioning coordinate downloaded from the server 220, so that the processing unit 211 may also not be connected to the server 220 and may search the storage unit 217 for the positioning coordinate where the contact performs landmark positioning at the geographic location.

For example, it is assumed that a user A intends to visit “Taipei City”. The user A may input or select a geographic location “Taipei City” in the electronic apparatus 210. At this time, the processing unit 211 may further determine positioning coordinates corresponding to “Taipei City” or a region range of “Taipei City”. The connection unit 213 logs in to the server 220 through an account, so that the processing unit 211 can determine, in the server 220, positioning coordinates where a plurality of contacts corresponding to the account performs landmark positioning at the positioning coordinates and numbers of times of landmark positioning. Here, it is assumed that contacts in a communication name list of the user A in the server 220, namely, a user B, a user C, a user D and a user E, all perform landmark positioning in the region range, and numbers of times of landmark positioning are 8, 1, 20, and 40 respectively. Accordingly, the processing unit 211 may sort the contacts according to the numbers of times of landmark positioning: the user E, the user D, the user B, and the user C.

That is to say, among the contacts of the user A, the user B, the user C, the user D, and the user E have been to “Taipei City”, and then it is determined which contact is possibly more familiar with “Taipei City” through the numbers of times of landmark positioning. It can be known from a searching result that the user E may be more familiar with “Taipei City” than others, so the user A may query the user E about information related to “Taipei City”. Furthermore, a threshold value may further be set to filter the searching result, so as to only list the contacts having a number of times of landmark positioning greater than the threshold value. For example, if the threshold value is set to 25, only the user E is output, and other contacts are not listed.

A storage medium is further provided, including instructions of a computer program product for executing the method for searching contacts. The computer program product basically consists of a plurality of program code segments (for example, program code segments for creating an organization chart, sign-off form program code segments, setting program code segments, and deployment program code segments). After the program code segments are loaded into the electronic apparatus and are executed, the steps of the method for searching contacts and the functions of the electronic apparatus can be implemented.

Based on the above, in the embodiments, by searching positioning coordinates where contacts perform landmark positioning, contacts having performed landmark positioning at a specified geographic location are searched for, so as to provide contacts worth being queried for reference by the user. The user can determine a query object according to the searching result.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A method for searching contacts, applicable to an electronic apparatus, the method comprising:
receiving a location information;
determining a geographic information corresponding to the location information;
determining at least one landmark positioning point corresponding to the geographic information;
calculating numbers of times of landmark positioning performed by a plurality of contacts at the at least one landmark positioning point;
sorting the plurality of contacts based on the numbers of times of landmark positioning of the contacts; and
displaying at least one of the contacts of the plurality of contacts according to the number of times of landmark positioning of each of the contacts.

2. The method for searching contacts according to claim 1, wherein after the step of receiving the location information, the method further comprises:
determining a region range according to the location information, so as to search for a contact performing landmark positioning in the region range.

3. The method for searching contacts according to claim 1, wherein after the step of receiving the location information, the method further comprises:
determining a region range according to the location information, so as to search for the landmark positioning point in the region range; and
searching for a contact performing landmark positioning at the landmark positioning point.

4. The method for searching contacts according to claim 1, further comprising:
connecting to a server;
logging in to the server according to an account;
reading, in the server, contacts corresponding to the account and a landmark positioning point where each of the contacts performs landmark positioning; and
searching for the landmark positioning point corresponding to the geographic information.

5. The method for searching contacts according to claim 1, wherein the step of determining the landmark positioning point corresponding to the geographic information comprises:
listing all the landmark positioning points corresponding to the geographic information; and
receiving a selection instruction for selecting the landmark positioning points.

6. The method for searching contacts according to claim 1, wherein after the step of calculating the numbers of times of landmark positioning performed by the contacts at the landmark positioning point, the method further comprises:
comparing the number of times of landmark positioning of each of the contacts with a threshold value, so as to list the contacts having a number of times of landmark positioning greater than the threshold value.

7. (canceled)

8. The method for searching contacts according to claim 1, wherein after the step of calculating the numbers of times of landmark positioning performed by the contacts at the landmark positioning point, the method further comprises:
obtaining a location of each of the contacts; and
sorting the contacts according to the location and the number of times of landmark positioning of each of the contacts.

9. The method for searching contacts according to claim 1, wherein after the step of calculating the numbers of times of landmark positioning performed by the contacts at the landmark positioning point, the method further comprises:
obtaining a location of each of the contacts; and
calculating a weight value of each of the contacts corresponding to the geographic information according to the location and the number of times of landmark positioning of each of the contacts to sort the contacts.

10. An electronic apparatus, comprising:
a connection unit, connected to a server, wherein the server comprises a plurality of landmark positioning points;
an output unit; and
a processing unit, coupled to the connection unit and the output unit respectively and connected to the server through the connection unit, wherein the processing unit receives a location information, determines a geographic information corresponding to the location information, determines a landmark positioning point corresponding to the geographic information, calculates numbers of times of landmark positioning performed by a plurality of contacts at the landmark positioning point, sorts the plurality of contacts based on the numbers of times of landmark positioning of the contacts, and displays at least one of the contacts of the plurality of contacts to the output unit according to the number of times of landmark positioning of each of the contacts.

11. The electronic apparatus according to claim 10, wherein after receiving the location information, the processing unit determines a region range according to the location information, so as to search for a contact performing landmark positioning in the region range.

12. The electronic apparatus according to claim 10, wherein the processing unit determines a region range according to the location information, so as to search for the landmark positioning point in the region range, and search for a contact performing landmark positioning at the landmark positioning point.

13. The electronic apparatus according to claim 10, wherein the processing unit logs in to the server according an account; reads, in the server, contacts corresponding to the account and a landmark positioning point where each of the contacts performs landmark positioning; and searches for the landmark positioning point corresponding to the geographic information.

14. The electronic apparatus according to claim 10, further comprising:
a storage unit, coupled to the processing unit, and storing all landmark positioning points downloaded from the server and where the contacts perform landmark positioning, so that the processing unit searches the storage unit for the landmark positioning point corresponding to the geographic information.

15. The electronic apparatus according to claim 10, wherein the processing unit further lists all landmark positioning points corresponding to the geographic information and receives a selection instruction for selecting the landmark positioning points.

16. The electronic apparatus according to claim 10, wherein the processing unit further lists all landmark positioning points corresponding to the geographic information and selects a landmark positioning point where the contacts perform landmark positioning from the landmark positioning points.

17. The electronic apparatus according to claim 10, wherein the processing unit compares the number of times of landmark positioning of each of the contacts at the landmark positioning point corresponding to the geographic information with a threshold value, so as to list the contacts having a number of times of landmark positioning greater than the threshold value, and sorts the contacts according to the numbers of times of landmark positioning.

18. (canceled)

19. The electronic apparatus according to claim 10, wherein the processing unit further obtains a location of each of the contacts; and calculates a weight value of each of the contacts corresponding to the geographic information according to the location and the number of times of landmark positioning of each of the contacts to sort the contacts.

20. A non-transitory storage medium, comprising a plurality of program code segments loaded into an electronic apparatus to execute the following steps:
receiving a location information;
determining a geographic information corresponding to the location information;
determining at least one landmark positioning point corresponding to the geographic information;
calculating numbers of times of landmark positioning performed by a plurality of contacts at the at least one landmark positioning point;
sorting the plurality of contacts based on the numbers of times of landmark positioning of the contacts; and
displaying at least one of the contacts according to the number of times of landmark positioning of each of the contacts.
